(19) United States
(12) Patent Application Publication
(10) Pub. No.: US 2017/0132667 A1
(43) Pub. Date: May 11, 2017

(54) REQUESTING PUBLISHER INFORMATION FOR RESOURCE PRESENTATION

(71) Applicant: Google Inc., Mountain View, CA (US)

(72) Inventor: Matthew Young-Lai, Kitchener (CA)

(21) Appl. No.: 13/931,430

(22) Filed: Jun. 28, 2013

(51) Int. Cl. G06Q 30/00

(52) U.S. Cl. CPC G06Q 30/0277

(57) ABSTRACT

A method performed by one or more processing devices includes receiving a request for a content item for placement with a resource provided by a publisher. The method also includes, in response to receiving the request for a content item, sending a request to the publisher for one or more constraints associated with content items for placement with the resource of the publisher. The method also includes receiving data from the publisher that provides the one or more constraints. The method also includes identifying a particular content item from a content item provider for placement with the resource based at least on applying the provided one or more constraints, and, providing the particular content item for presentation with the resource provided by the publisher.

### BACKGROUND

This specification relates to data processing and content presentation.

The Internet provides access to a wide variety of resources. For example, video and/or audio files, as well as web pages for particular subjects such as particular news articles are accessible over the Internet. Access to these resources presents opportunities for content items (e.g., advertisements, audio files, or video files) to be provided with the resources. For example, a web page can include content item slots (e.g., advertisement slots) in which content items (e.g., advertisements) can be presented. These content item slots can be defined in the web page using a portion of code that causes a browser to request a content item for presentation in the web page when the browser renders the web page. A content item distribution system selects content items for presentation in response to the request. The content item distribution system can select the content items based on information included in the request.

### SUMMARY

This document describes methods and systems (e.g., an advertisement distribution system) for automated requesting of constraints from a publisher regarding the content items to be presented in a resource such as a web page. Requested and applied as a resource is being presented, such constraints may assist with content item selection, for example, by providing a pricing limit that a publisher may define as a floor for an advertiser to pay for having an advertisement presented in the publisher's resource. Constraints may also limit other aspects of advertisement selection; for example, some constraints may go as far as blocking particular advertisements (or other content items) from appearing with a resource after being deemed ineligible by the publisher of the resource. For example, a publisher of an educational website may deem advertisements for a particular scary movie as inappropriate for being presented on the website. Other factors (e.g., the geographic location and demographic information of an end viewer) or combinations of factors may be identified by the constraints provided by the publishers in an efficient manner during the time that resources are being prepared for presentation.

In one aspect, a method performed by one or more processing devices includes receiving a request for a content item for placement with a resource provided by a publisher. The method also includes, in response to receiving the request for a content item, sending a request to the publisher for one or more constraints associated with content items for placement with the resource of the publisher. The method also includes receiving data from the publisher that provides the one or more constraints. The method also includes identifying a particular content item from a content item provider for placement with the resource based at least on applying the provided one or more constraints, and, providing the particular content item for presentation with the resource provided by the publisher.

Implementations of the disclosure can include one or more of the following features. Identifying a particular content may include conducting an auction to identify the particular content item for placement with the published content. Identifying a particular content item may include communicating with the advertiser to identify the particular content item. Applying the provided one or more constraints may include preventing presentation of a content item with the resource. At least one of the one or more constraints may represent a minimum acceptable price from the publisher for placing a content item with the resource. The request sent to the publisher may be sent to an application program interface capable of responding to provide the one or more constraints for identifying the content item. The received request for placement of a content item may be provided by an identifier assigned to the resource by a web browser. The content item may include an advertisement from an advertiser. Sending the request to the publisher may occur based on a user device accessing the resource for presentation.

In another aspect, one or more machine-readable media configured to store instructions that are executable by one or more processing devices to perform operations that include receiving a request for a content item for placement with a resource provided by a publisher. In response to receiving the request for a content item, operations include sending a request to the publisher for one or more constraints associated with content items for placement with the resource of the publisher. Operations include receiving data from the publisher that provides the one or more constraints. Operations include identifying a particular content item from a content item provider for placement with the resource based at least on applying the provided one or more constraints, and, providing the particular content item for presentation with the resource provided by the publisher.

Implementations of the disclosure can include one or more of the following features. Identifying a particular content may include conducting an auction to identify the particular content item for placement with the published content. Identifying a particular content item may include communicating with the advertiser to identify the particular content item. Applying the provided one or more constraints may include preventing presentation of a content item with the resource. At least one of the one or more constraints may represent a minimum acceptable price from the publisher for placing a content item with the resource. The request sent to the publisher may be sent to an application program interface capable of responding to provide the one or more constraints for identifying the content item. The received request for placement of a content item may be provided by an identifier assigned to the resource by a web browser. The content item may include an advertisement from an advertiser. Sending the request to the publisher may occur based on a user device accessing the resource for presentation.

In still another aspect, an electronic system includes one or more processing devices. The electronic system also includes one or more machine-readable media configured to store instructions that are executable by the one or more processing devices to perform operations that include receiving a request for a content item for placement with a resource provided by a publisher. In response to receiving the request for a content item, operations include sending a request to the publisher for one or more constraints associated with content items for placement with the resource of the publisher. Operations include receiving data from the publisher that provides the one or more constraints. Operations include identifying a particular content item from a content item provider for placement with the resource based at least on applying the provided one or more constraints, and, providing the particular content item for presentation with the resource provided by the publisher.

Implementations of the disclosure can include one or more of the following features. Identifying a particular content may include conducting an auction to identify the particular content item for placement with the published content. Identifying a particular content item may include communicating with the advertiser to identify the particular content item. Applying the provided one or more constraints may include preventing presentation of a content item with the resource. At least one of the one or more constraints may represent a minimum acceptable price from the publisher for placing a content item with the resource. The request sent to the publisher may be sent to an application program interface capable of responding to provide the one or more constraints for identifying the content item. The received request for placement of a content item may be provided by an identifier assigned to the resource by a web browser. The content item may include an advertisement from an advertiser. Sending the request to the publisher may occur based on a user device accessing the resource for presentation.

Other embodiments of this aspect include corresponding systems, apparatus, and computer programs, configured to perform the actions of the methods, encoded on computer storage devices.

Particular embodiments of the subject matter described in this specification can be implemented so as to realize one or more of the following advantages. Publishers, third parties that represent publishers, etc. are provided an interface that allows for real-time adjusting of constraints to identify advertisements for inclusion in the publisher's resource such as a website. By allowing constraints such as setting a minimum cost, ineligible advertisements to be identified, etc. to be dynamically set, a publisher is provided flexibility to quickly configure and reconfigure their resources.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which content items are distributed to user devices.

FIG. 2 is a block diagram of an example data flow for allowing a publisher to dynamically set constraints for content items such as advertisements.

FIG. 3 is a flow chart of an example process for placing constraints on content items.

FIG. 4 is block diagram of an example computer system.

Like reference numbers and designations in the various drawings indicate like elements.

### DETAILED DESCRIPTION

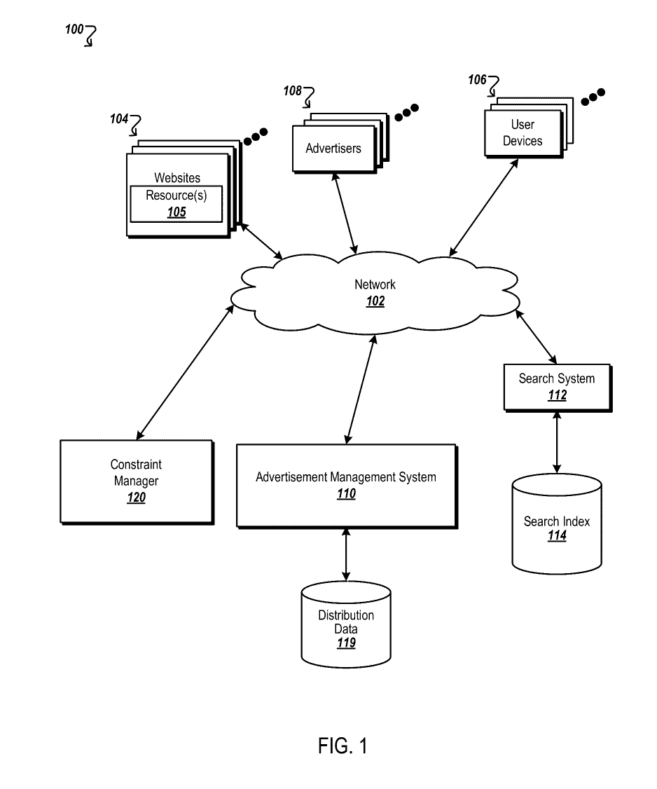

FIG. 1 is a block diagram of an example environment 100 in which content items are distributed to user devices. A content item is a discrete unit of data that can be presented with a resource. For example, a content item can be a file, data, etc. that is provided for insertion in a portion of a resource that is presented at a user device.

The environment 100 includes an advertisement management system 110 that manages advertising services. The example environment 100 also includes a network 102, such as a local area network (LAN), a wide area network (WAN), the Internet, or a combination thereof. The network 102 connects websites 104, user devices 106, advertisers 108, and the advertisement management system 110. The example environment 100 may include any number of websites 104, user devices 106, and advertisers 108. FIG. 1 is discussed with reference to advertisements being distributed to user devices, but other types of content items (e.g., audio files, video files, or other files) can be distributed in the environment as well.

A website 104 is one or more resources 105 associated with a domain name and hosted by one or more servers. An example website is a collection of web pages formatted in hypertext markup language (HTML) that can contain text, images, multimedia content, and programming elements, such as scripts. In general, each website 104 is controlled by a publisher to a certain extent. For example, each website may be maintained, managed, owned, etc. by one or more publishers.

A resource 105 is any data that can be provided over the network 102. A resource 105 can be identified by a resource address that is associated with the resource 105. Resources include HTML pages, word processing documents, and portable document format (PDF) documents, images, video, and feed sources, to name only a few. The resources can include content, such as words, phrases, images and sounds, that may include embedded information (such as meta-information in hyperlinks) and/or embedded instructions (such as scripts).

A user device 106 is an electronic device that is capable of requesting and receiving resources over the network 102. Example user devices 106 include personal computers, mobile communication devices, and other devices that can send and receive data over the network 102. A user device 106 typically includes a user application, such as a web browser, to facilitate the sending and receiving of data over the network 102.

A user device 106 can request resources 105 from a website 104. For example, a browser executed by the user device 106 may be configured to request a webpage from a publisher. The publisher may be considered an individual entity, a third party entity that provides services to a publisher, a combination of entities, etc. To provide such webpages, the publisher may operate one or more computing devices (e.g., servers). In one arrangement, when the user types a URL for a webpage into the browser of the user device 106, the browser requests the webpage from the publisher. In other implementations, the user may view a webpage using the browser and select a link contained in the webpage. Selecting the link typically causes the browser to request a second webpage associated with the link from the publisher. Once identified, data representing the resource 105 can be provided to the user device 106 for presentation by the device. The data representing the resource 105 can also include data specifying a portion of the resource or a portion of a user display in which advertisements or other types of content items can be presented. These specified portions of the resource or user display are referred to as content item slots or advertisement slots.

When a resource 105 is requested by a user device 106, the advertisement management system 110 receives a request for advertisements to be provided with the resource 105. The request for advertisements can include characteristics of the advertisement slots that are defined for the requested resource, and can be provided to the advertisement management system 110. For example, a reference (e.g., URL) to the resource (e.g., a retailer's web page or a web page for a sports network) for which the advertisement slot is defined, a size of the advertisement slot, and/or media types that are authorized for presentation in the advertisement slot can be provided to the advertisement management system 110. Similarly, keywords associated with a requested resource (“resource keywords”) can also be provided to the advertisement management system 110 to facilitate identification of advertisements that are relevant to the resource.

Based on data included in the request for advertisements, the advertisement management system 110 can select advertisements that are eligible to be provided in response to the request (“eligible advertisements”). For example, eligible advertisements can include advertisements having characteristics matching the characteristics of advertisement slots and that are identified as relevant to specified resource keywords. In some implementations, advertisements having associated keywords that match the resource keywords are selected as eligible advertisements by the advertisement management system 110. One or more constraints set by the publisher may also factor into the identification and selection of eligible advertisements.

The environment 100 includes a distribution data store 119 that stores data with which the advertisement management system 110 (or another content item distribution system) selects advertisements (or other content items) for presentation with a resource. The distribution data store 119 can include, for example, distribution parameters, such as distribution keywords and/or bids, etc. with which distribution of the advertisements is controlled. For example, an advertisement that is associated with a particular set of keywords may only be eligible for distribution when an advertisement request including a resource keyword that matches the distribution keyword is received. Eligibility of a particular advertisement for presentation with a particular resource can be based, at least in part, on constraints set by the publisher. Such a constraint may include requesting that the advertisement be blocked from presentation. For example, a publisher of an educational web site may not want advertisements for a scary movie to be presented with pages from the educational web site and may send a blocking request to the advertisement management system 110. Such a request may specify a network location (e.g., a page URL or a top level domain) of a web page for the scary movie. When advertisements are selected for presentation with pages from the educational web site, the advertisement management system 110 can prevent that advertisement from being selected for presentation.

Eligibility may also be based on other quantities such as monetary amounts that publisher is willing to accept from an advertiser. For example, a publisher may set a particular floor amount on a per impression basis (e.g., the display of an advertisement by the device user). A variety of pricing models and types may be used for setting cost and may include, but are not limited to, cost per impression (CPI); cost per thousand impressions (CPM); cost per action (CPA); cost per click (CPC); cost per lead (CPL); cost per order (CPO); or cost per sale (CPS). In general, CPI represents a cost to an advertiser for one impression. For example, a CPI bid of $0.15 may indicate that an advertiser is willing to pay $0.15 for an impression. CPM pricing is based on the number of views, or impressions, that an advertisement may receive over a period of time. For example, a CPM bid of $50 may indicate that an advertiser would pay $50 for every 1,000 times an advertisement is displayed. CPA pricing is based on the number of actions that occur in response to an advertisement. An action may be defined as a sales transaction, a customer acquisition, or a click on the advertisement. CPC pricing is based on the number of times an advertisement is clicked or selected. For example, an advertisement may be associated with a bid to pay 10 cents for every click on the advertisement. CPL pricing is based on the number of new leads generated by an advertisement. For example, an advertiser may pay for every user that clicks on an advertisement and successfully completes a form on a webpage associated with the advertisement. CPO pricing is based on the number of orders received as a result of an advertisement. CPS pricing is based on the number of sales transactions that an advertisement generates.

Similar to one or more monetary values, other types of constraints may be used by a publisher for controlling the advertisements used with a resource such as a webpage. For example, creative constraints may indicate advertisement formats, layouts etc. that are to be used, excluded, etc. with the displayed as part of a webpage. For example, one constraint from a publisher can indicate that advertisements that include video or audio content are excluded from being displayed on the webpage. As another example, the constraint can indicate that expandable advertisements are excluded from being displayed on the webpage.

By using such constraints, the advertisement management system 110 can identify one or more advertisements for presentation with the resource 105. In this illustrated example, the distribution data store 119 stores data with which the advertisement management system 110 (or another content item distribution system) selects advertisements (or other content items) for presentation with a resource. The distribution data store 119 can include, for example, distribution parameters that reflect information associated with constraints (e.g., minimum CPM, keywords, etc.), with which distribution of the advertisements is controlled.

The advertisement management system 110 can conduct an internal auction among several advertisers, for example, associated with an advertising campaign. The advertisement management system 110 can select an advertiser associated with a bid (e.g., highest bid) in the internal auction. In addition to using bid information provided by the advertisers 108, the constraints such as a minimum CPM defined by a publisher may be used for selecting an advertiser. Often the constraints are provided by the publishers 108 to the advertisement management system 110 far in advance of the constraints being used for selecting appropriate advertisements. In effect, the constraints can be considered static and the publishers are generally unable to make adjustments to the constraints during their use in advertisement selection. To allow the publishers to dynamically adjust the constraints, the environment 100 includes a constraint manager 120 that interfaces with the publishers 108 and may use various forms and architectures to dynamically set, adjust, etc. constraints (e.g., minimum CPM), for example, for an auction associated the resource 105. In the illustrated example, the constraint manager 120 is shown being located separate from the advertisement management system 110; however, in some implementations the constraint manager may be integrated into the advertisement management system 110. One or more techniques may be utilized by the constraint manager 120 for allowing the constraints to be adjusted by the publishers; for example, one or more interfaces (e.g., an application programming interface) may be provided to the publisher (e.g., presented on a computing device) for collecting constraint information (e.g., for adjusting one or more constraints). Provided to the advertisement management system 110, the constraint information may correspondingly be used in the auction for identifying the advertisements. For example, alerted that auction is to be initiated, the publisher may change the minimum CPM threshold for potentially accepting an advertisement from one of the advertisers 108. By allowing such dynamic updates, a publisher may affect the selection of an advertisement in near real-time without being tied to predefined static preferences.

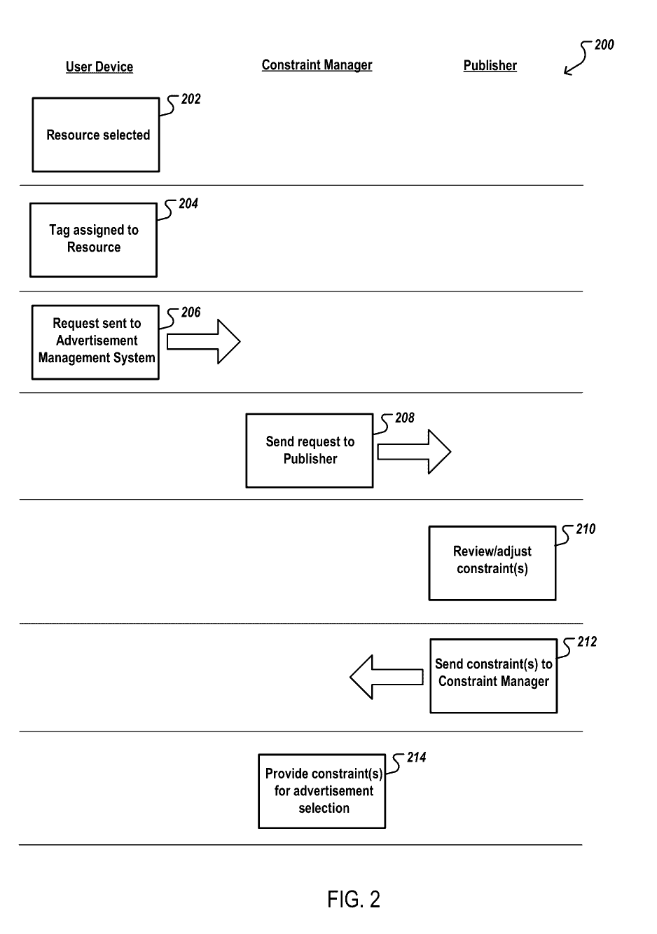

Referring to FIG. 2, an example data flow 200 illustrates operations executed in the environment 100 (shown in FIG. 1) that allow a publisher to dynamically adjust constraints for identifying advertisements or other types of content items for placement in a resource such as a webpage. Once a resource is selected 202 through a user device (e.g., by entering a URL into the device, selecting a link, etc.), an identifier (e.g., a tag) is assigned 204 to the resource. For example, a web browser executed by the user device may assign such an identifier to the instance of the resource to be presented on the device. To initiate the process of selecting and providing one or more advertisements to the resource (e.g., identify an advertisement for placement in an advertisement slot in the resource), a request is sent 206 to the advertisement management system 110 (shown in FIG. 1) for the needed advertisement(s). The advertisement management system provides the request (or information contained in the request) to the constraint manager 120 (also shown in FIG. 1), which may be integrated into or separate from the management system. Once informed of the request from the resource, the constraint manager 120 sends 208 a request to the publisher associated with the resource. As mentioned above, a publisher may represent different types of entities; for example, the term may be used to represent the publisher of the resource (e.g., the owner of the website). The term publisher may also represent an entity that manages resources for a number of individual publishers. For example a third party entity (e.g., business, corporation, etc.) may manage the type of content items (e.g., advertisements) to be presented in resources (e.g., websites) for a network of publishers.

Upon receiving the request, one or more types of interfacing techniques may be used by the publisher for reviewing constraints associated with the resource along with other information. For example an API may be used by the publisher for reviewing and adjusting 210 constraints. A variety of quantities may be adjusted through the API, for example, the minimum CPM may be adjusted by the publisher for selecting advertisements to be placed with the resource. The request provided to the API may also include additional information that may provide assistance. For example, information associated with the device and/or user (e.g., geographic location, identification, etc.), information related to the resource (e.g., resource type, access authorization, etc.) and other types of information may be included and used for setting or adjusting constraints. In some arrangements, estimated or previously used monetary quantities (e.g., previous CPM, etc.) may be included in the request for use by the API. Upon being adjusted, the API (e.g., executed by the publisher's computing device) may send 212 the constraints to the constraint manager 120. Once received, the constraints may be provided 214 for use in one or more techniques for selecting appropriate advertisements and other types of content items. For example, the constraints may be used in an auction executed for identifying the advertisements for the selected resource. In another example, constraints that identify ineligible advertisements (or other types of content items) may be used for blocking their use with the resource. From these provided constraints, the publishers are able to actively take part in the selection process during the time period in which the advertisers are similarly active (e.g., providing bids, etc.). In some arrangements, similar timing deadlines (e.g., for sending information, etc.) may be similarly applied to both publishers and advertisers. Once the particular advertisement is identified through these techniques, the advertisement management system 110 may then move forward for having the resource and identified content items presented on the user device.

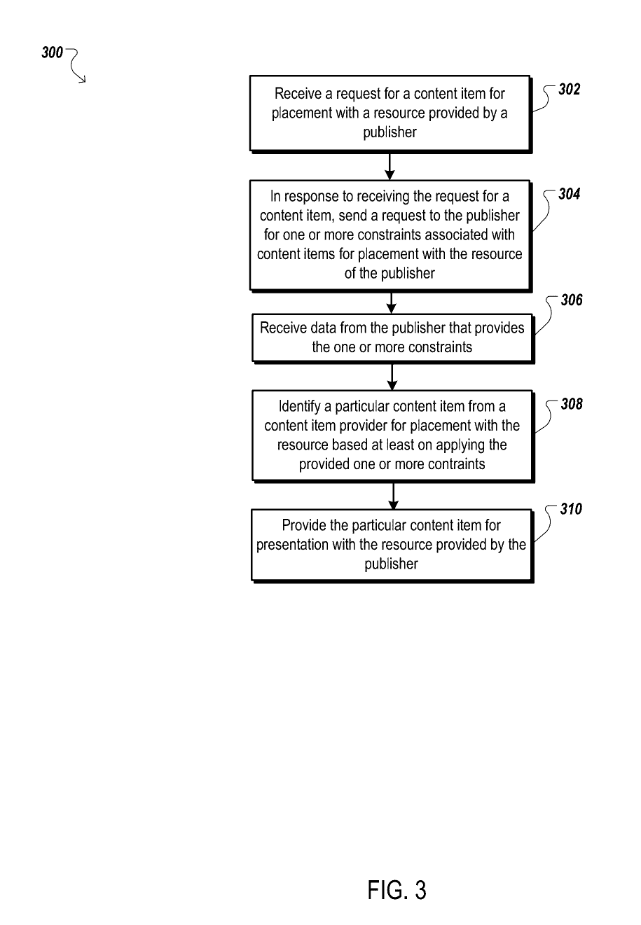

FIG. 3 is a flow chart of an example process 300 for dynamically allowing a publisher to adjust constraints that are then used to identify content items such as advertisements (e.g., through an auction with advertisers). Execution of the process typically occurs as the content items are requested for inclusion in a resource. Operations of the process 300 can be implemented by a data processing apparatus, such as the constraint manager 120 and/or advertisement management system 110 of FIG. 1. The process can also be implemented as instructions stored on a non-transitory computer storage medium such that execution of the instructions by a data processing apparatus causes the data processing apparatus to perform operations of the process 300.

Operations of the process may include receiving (302) a request for a content item for placement with a resource provided by a publisher. For example, such a request may be provided to the constraint manager 120 from a tag assigned to a resource (e.g., a webpage) being accessed by a user device. In response to receiving the request, operations may also include sending (304) a request to the publisher for one or more constraints associated with content items for placement with the resource of the publisher. For example, such a constraint request may be provided to an API to allow a publisher, a third parties representing one or more publishers, etc. to select, adjust, etc. one or more constraints (e.g., a minimum CPM, types of content items to be blocked from presentation with a resource, etc.). Once the constraint selections, adjustments, etc. have been executed, operations may include receiving (306) data from the publisher that provides the one or more constraints. For example, a message or other type of data transmission technique may be used by sending the constraint information from the API used by the publisher. Operations may also include identifying (308) a particular content item from a content item provider for placement with the resource based at least on applying the provided one or more constraints. For example, the received constraints may be used in an auction (e.g., to set the floor CPM for advertiser bids), by a process (e.g., to identify advertisements to be blocked from being inserted in slots of the resource), or other type of uses. Operations may also include providing (310) the particular content item for presentation with the resource provided by the publisher. For example, one or more advertisements, identified at the completion of an auction, may be prepared for being inserted into a corresponding advertisement slot of a webpage and sent to the user device for presentation. By allowing a publisher to set or adjust constraints as resources are prepared for presentation, the process of selecting advertisements and other types of content items may be dynamically altered, nearly in real-time in some instances, to increase involvement provide more flexibility to the publisher.

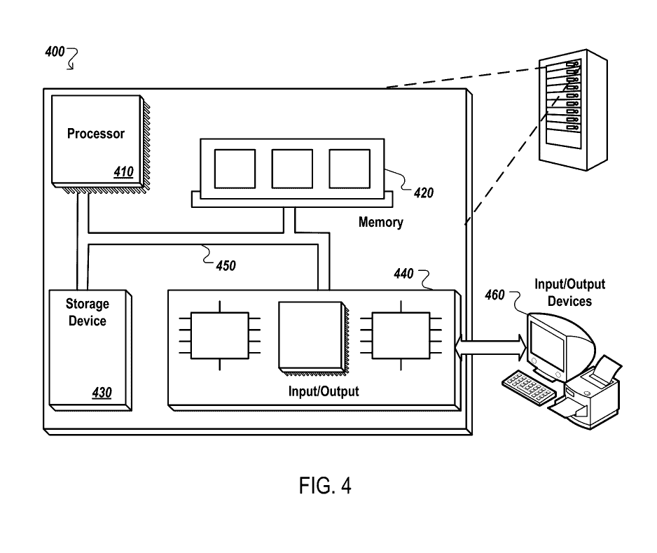

FIG. 4 is block diagram of an example computer system 400 that can be used to perform operations described throughout this document. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of the claims or what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by one or more servers, comprising:
receiving a request for a content item for placement with an online resource of a publisher;
in response to receiving the request for the content item, sending a request to the publisher for one or more constraints of the publisher for placement of content items with the online resource of the publisher;
receiving from the publisher information indicative of the one or more constraints of the publisher, with the one or more constraints specifying one or more characteristics for a content item to be eligible for display in the online resource of the publisher;
conducting, by one or more servers, an auction among a plurality of content items for content item placement with the online resource of the publisher;
during the auction, providing, by the one or more servers to a user device, one or more interfaces for near real-time adjustment of the one or more constraints at the user device;
during the auction, receiving, by the one or more servers through interaction at the user device with the one or more interfaces, information indicative of a near real-time adjustment to the one or more constraints of the publisher;
monitoring, in real-time by the one or more servers, compliance of the plurality of content items with the near real-time adjustment to the one or more constraints;
when a particular content item in the plurality of content items complies with the adjustment to the one or more constraints, automatically enabling, by the one or more servers, presentation of the particular content item with the online resource; and
when the particular content item is non-compliant with the adjustment to the one or more constraints, automatically disabling, by the one or more servers, presentation of the particular content item with the online resource.

2. (canceled)

3. The method of claim 1, further comprising communicating with an advertiser to identify the particular content item.

4. The method of claim 1, further comprising applying the one or more constraints.

5. The method of claim 1, wherein at least one of the one or more constraints represents a minimum acceptable price from the publisher for content item placement with the online resource.

6. The method of claim 1, wherein the request sent to the publisher is sent to an application program interface capable of responding to provide the information indicative of the one or more constraints.

7. The method of claim 1, wherein the received request for placement of the content item is provided by an identifier assigned to the online resource by a web browser.

8. The method of claim 1, wherein the particular content item comprises an advertisement from an advertiser.

9. The method of claim 1, wherein sending the request to the publisher occurs based on the user device accessing the online resource for presentation.

10. One or more machine-readable media storing instructions that are executable by one or more servers to perform operations comprising:
receiving a request for a content item for placement with an online resource of a publisher;
in response to receiving the request for the content item, sending a request to the publisher for one or more constraints of the publisher for placement of content items with the online resource of the publisher;
receiving from the publisher information indicative of the one or more constraints of the publisher, with the one or more constraints specifying one or more characteristics for a content item to be eligible for display in the online resource of the publisher;
conducting, by one or more servers, an auction among a plurality of content items for content item placement with the online resource of the publisher;
during the auction, providing, by the one or more servers to a user device, one or more interfaces for near real-time adjustment of the one or more constraints at the user device;
during the auction, receiving, by the one or more servers through interaction at the user device with the one or more interfaces, information indicative of a near real-time adjustment to the one or more constraints of the publisher;
monitoring, in real-time by the one or more servers, compliance of the plurality of content items with the near real-time adjustment to the one or more constraints;
when a particular content item in the plurality of content items complies with the adjustment to the one or more constraints, automatically enabling, by the one or more servers, presentation of the particular content item with the online resource; and
when the particular content item is non-compliant with the adjustment to the one or more constraints, automatically disabling, by the one or more servers, presentation of the particular content item with the online resource.

11. (canceled)

12. The one or more machine-readable media of claim 10, wherein the operations further comprise communicating with an advertiser to identify the particular content item.

13. The one or more machine-readable media of claim 10, wherein the operations further comprise applying the one or more constraints.

14. The one or more machine-readable media of claim 10, wherein at least one of the one or more constraints represents a minimum acceptable price from the publisher for content item placement with the online resource.

15. The one or more machine-readable media of claim 10, wherein the request sent to the publisher is sent to an application program interface capable of responding to provide the information indicative of the one or more constraints.

16. The one or more machine-readable media of claim 10, wherein the received request for placement of the content item is provided by an identifier assigned to the online resource by a web browser.

17. The one or more machine-readable media of claim 10, wherein the particular content item comprises an advertisement from an advertiser.

18. The one or more machine-readable media of claim 10, wherein sending the request to the publisher occurs based on the user device accessing the online resource for presentation.

19. An electronic system comprising:
one or more servers, and
one or more machine-readable media storing instructions that are executable by the one or more servers to perform operations comprising:
receiving a request for a content item for placement with an online resource of a publisher;
in response to receiving the request for the content item, sending a request to the publisher for one or more constraints of the publisher for placement of content items with the online resource of the publisher;
receiving from the publisher information indicative of the one or more constraints of the publisher, with the one or more constraints specifying one or more characteristics for a content item to be eligible for display in the online resource of the publisher;
conducting, by the one or more servers, an auction among a plurality of content items for content item placement with the online resource of the publisher;
during the auction, providing, by the one or more servers to a user device, one or more interfaces for near real-time adjustment of the one or more constraints at the user device:
during the auction, receiving, by the one or more servers through interaction at the user device with the one or more interfaces, information indicative of a near real-time adjustment to the one or more constraints of the publisher;
monitoring, in real-time by the one or more servers, compliance of the plurality of content items with the near real-time adjustment to the one or more constraints;
when a particular content item in the plurality of content items complies with the adjustment to the one or more constraints, automatically enabling, by the one or more servers, presentation of the particular content item with the online resource; and
when the particular content item is non-compliant with the adjustment to the one or more constraints, automatically disabling, by the one or more servers, presentation of the particular content item with the online resource.

20. (canceled)

21. The electronic system of claim 19, wherein the operations further comprise communicating with an advertiser to identify the particular content item.

22. The electronic system of claim 19, wherein the operations further comprise applying the one or more constraints.

23. The electronic system of claim 19, wherein at least one of the one or more constraints represents a minimum acceptable price from the publisher for content item placement with the online resource.

24. The electronic system of claim 19, wherein the request sent to the publisher is sent to an application program interface capable of responding to provide the information indicative of the one or more constraints.

25. The electronic system of claim 19, wherein the received request for placement of the content item is provided by an identifier assigned to the online resource by a web browser.

26. The electronic system of claim 19, wherein the particular content item comprises an advertisement from an advertiser.

27. The electronic system of claim 19, wherein sending the request to the publisher occurs based on the user device accessing the online resource for presentation.

28. The computer-implemented method of claim 1, wherein conducting the auction comprises:
transmitting a request to the publisher to determine whether the publisher seeks to adjust a cost per impression (CPI) constraint, a cost per thousand impressions (CPM) constraint, a cost per action (CPA) constraint, a cost per click (CPC) constraint, a cost per lead (CPL) constraint, a cost per order (CPO), or a cost per sale (CPS) constraint;
wherein during the auction receiving the information indicative of the adjustment comprises:
receiving information indicative of an adjustment to the cost per impression (CPI) constraint, the cost per thousand impressions (CPM) constraint, the cost per action (CPA) constraint, the cost per click (CPC) constraint, the cost per lead (CPL) constraint, the cost per order (CPO), or the cost per sale (CPS) constraint; and
wherein the method further comprises applying the adjustment to the cost per impression (CPI) constraint, the cost per thousand impressions (CPM) constraint, the cost per action (CPA) constraint, the cost per click (CPC) constraint, the cost per lead (CPL) constraint, the cost per order (CPO), or the cost per sale (CPS) constraint to characteristics of the plurality of content items participating in the auction.

29. The computer-implemented method of claim 1, wherein conducting the action comprises transmitting a request to the publisher to determine whether the publisher seeks to adjust at least one of the one or more constraints.
